(19) United States
(12) Patent Application Publication
(10) Pub. No.: US 2018/0276670 A1
(43) Pub. Date: Sep. 27, 2018

(54) COGNITIVE CONTROLLED CREDIT CARD AUTHORIZATION

(71) Applicant: INTERNATIONAL BUSINESS MACHINES CORPORATION, Armonk, NY (US)

(72) Inventors: Asmahan A. Ali, Highland, NY (US); Ali Y. Duale, Poughkeepsie, NY (US); Mustafa Y. Mah, Highland, NY (US)

(21) Appl. No.: 15/468,938

(22) Filed: Mar. 24, 2017

(51) Int. Cl. G06Q 20/40; G06Q 20/34

(52) U.S. Cl. CPC G06Q 20/4093; G06Q 20/357

(57) ABSTRACT

Embodiments include method, systems and computer program products for credit card authorization. Aspects include receiving, by a processor, credit card information for a consumer. A consumer profile is received that includes one or more spending categories. Each of the one or more spending categories is associated with one or more spending restrictions. A request to authorize a charge for the credit card is received and a spending category for the charge is determined. The charge is authorized based on a determination that the charge does not violate any of the one or more spending restrictions associated with the spending category for the charge.

### BACKGROUND

The present disclosure relates to credit card systems and, more specifically, to methods and systems for cognitive controlled credit card authorization.

Consumer credit card transactions have achieved widespread use. These transactions are performed every day over the Internet and through point of sale or banking systems. These credit card transactions are usually performed after authentication of information about the credit card holder. Limitations on purchasing with a credit card are restricted to a card holder's authorization and credit limits imposed by the credit card issuer.

An additional limitation on credit card usage could assist a card holder with budgeting and achieving financial goals.

### SUMMARY

Embodiments include a computer-implemented method for credit card authorization, the method includes receiving, by a processor, credit card information for a consumer. A consumer profile is received that includes one or more spending categories. Each of the one or more spending categories is associated with one or more spending restrictions. A request to authorize a charge for the credit card is received and a spending category for the charge is determined. The charge is authorized based on a determination that the charge does not violate any of the one or more spending restrictions associated with the spending category for the charge.

Embodiments include a computer system for credit card authorization, the computer system for credit card authorization having a processor, the processor configured to perform a method. The method includes receiving, by a processor, credit card information for a consumer. A consumer profile is received that includes one or more spending categories. Each of the one or more spending categories is associated with one or more spending restrictions. A request to authorize a charge for the credit card is received and a spending category for the charge is determined. The charge is authorized based on a determination that the charge does not violate any of the one or more spending restrictions associated with the spending category for the charge.

Embodiments also include a computer program product for credit card authorization, the computer program product including a computer readable storage medium having computer readable program code embodied therewith. The computer readable program code including computer readable program code configured to perform a method. The method includes receiving, by a processor, credit card information for a consumer. A consumer profile is received that includes one or more spending categories. Each of the one or more spending categories is associated with one or more spending restrictions. A request to authorize a charge for the credit card is received and a spending category for the charge is determined. The charge is authorized based on a determination that the charge does not violate any of the one or more spending restrictions associated with the spending category for the charge.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 illustrates a block diagram of a computer system according to one or more embodiments of the present invention;

FIG. 4 illustrates a block diagram of a system for credit card authorization according to one or more embodiments of the present invention;

FIG. 5 illustrates a flow diagram of a method for credit card authorization according to one or more embodiments of the present invention; and

FIG. 6 illustrates a flow diagram of an illustrative method for credit card authorization according to one or more embodiments of the present invention.

### DETAILED DESCRIPTION

In accordance with exemplary embodiments of the present invention, methods, systems and computer program products for credit card authorization are provided. In one or more exemplary embodiments, methods for credit card authorization include financial rules associated with a credit card for a credit card holder. These financial rules can help determine whether a charge is authorized or denied by a credit card authorization system. These financial rules along with historical spending data can cognitively assist a consumer with credit purchases to promote financial health of a consumer. Categories of spending can be pre-defined by the consumer while utilizing a credit card and certain spend limits can restrict the consumer from exceeding financial goals.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

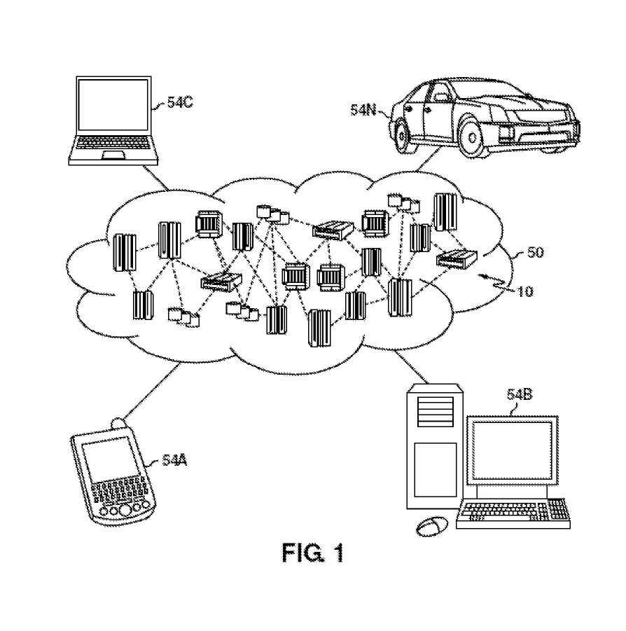

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

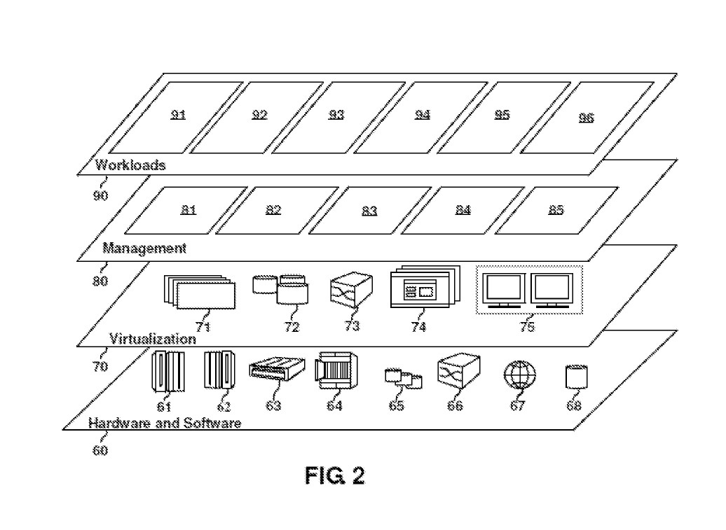

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and transaction authorization 96.

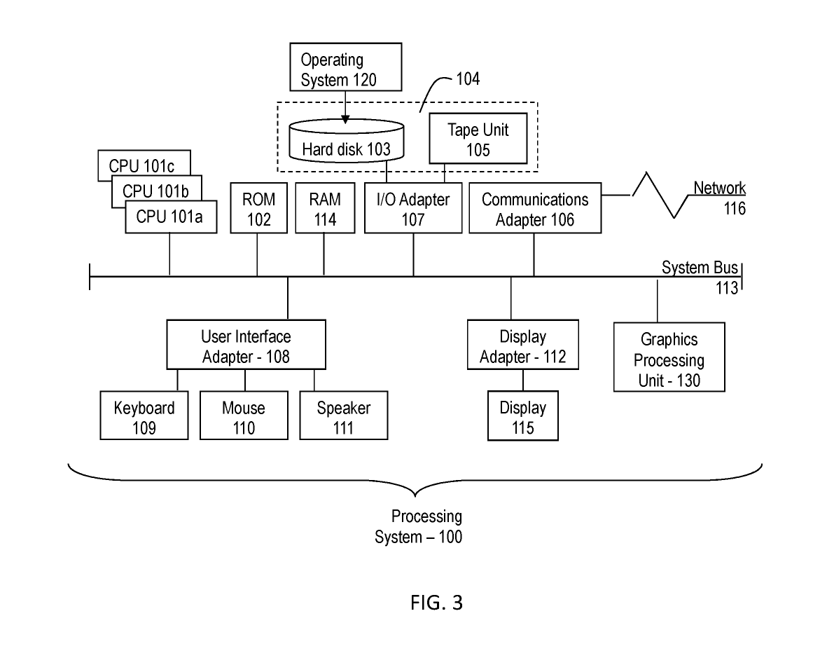

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one or more embodiments, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 3.

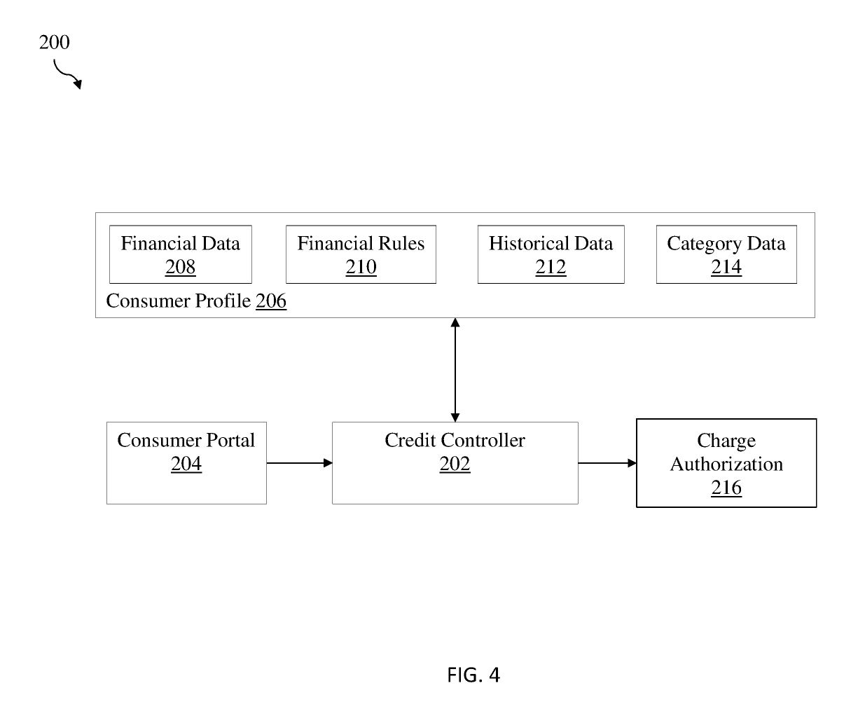

Referring to FIG. 4 there is shown a system 200 for credit card authorization according to one or more embodiments. The system 200 includes a credit controller 202, a consumer portal 204, consumer profile data 206, and a charge authorization 216. In one or more embodiments, the consumer portal 204 can by a web portal or a smart phone application on the consumer's smart phone.

In one or more embodiments, the credit controller 202 can be implemented on the processing system 100 found in FIG. 3. The credit controller 202 cognitively assists a consumer (credit card holder) to control the consumer's finances by establishing financial rules to authorize, deny, or delay credit card charges. The consumer portal 204 allows a consumer to enter in information about the consumer's financial goals and set restrictions on spending limits and categories of spending for the consumer's credit cards which assists in establishing the financial rules 210. Additionally, pre-set financial rules can be utilized by the card holder, such as, for example, a pre-set percentage of total spending for categories such as necessities, food, and entertainment. The percentages can be taken from population data about what percentage of a budget certain categories typically occupy for a given population of people. These financial rules 210 are stored in the customer profile 206. The credit controller 202 can send a charge authorization 216 to a credit provider based at least in part on a credit transaction being in line with the consumer profile 206 and financial rules (spending restrictions) 210.

In one or more embodiments, a consumer can utilize the consumer portal 204 to input financial data 208 for the consumer profile 206. The financial data 208 can include checking, savings, and any other financial account information. The consumer can also link the consumer's credit cards with one or more bank accounts and/or savings accounts to update the consumer profile 206.

In one or more embodiments, historical data 212 is stored in the consumer profile 206. Historical data 212 can include previous purchases on a credit card and also total spending for a credit card per month or per year. Historical data 212 can also include any recurring purchases made on the consumer's credit cards each week, month, or any other time period. The consumer profile 206 can also include category data 214 which includes categories of spending for the consumer as well as any spend limits designated by the consumer.

In one or more embodiments, the system 200 can cognitively assist the consumer to be financial health. The system 200 integrates a consumer's credit card with the consumer's checking account and/or savings account as well as shopping preferences and expense limitations. Charge authorizations 216 will be augmented to a consumer's financial status and/or financial goals. For example, a consumer utilizes his/her credit card for monthly expenses and utilizes the system 200 to control and cognitively manage these monthly expenses with some pre-defined and on-the-fly flexibility with spending. Financial goals can include sustaining a certain percentage of money in the savings account. Each month, the savings account can be incremented by a minimum amount or percentage to meet financial goals set by the consumer. Historical data, the status of a saving account, as well as predefined amounts or percentages for previous or current charges are used to determine if a current charge is honored or denied.

For example, a consumer has linked his credit card (Card A) to a checking account. Financial rules 210 are defined to limit the amount of money that Card A can utilize in a month. For Card A, a monthly allowance includes specific spending category data 214 and defines a spending limit for each of these categories. An example category is entertainment which would allow for spending on transactions such as movie rentals, movie tickets, and the like. An entertainment category spend limit could be set at $150 for this particular consumer. Additional example categories include essentials, utilities, and reserves. Each of these categories has a spending limit associated with the category which can be defined in the financial rules 210 and consumer profile 206. When the consumer exceeds the maximum spending limit for a certain category, Card A will be turned off for that particular category. Having the card turned off can include deny transactions and/or requiring additional authorization from the consumer or from an additional party.

In one or more embodiments, the spending categories 214 can include high risk categories. These high risk categories can be tied to activities or purchases that can lead to impulse control issues. To reduce the risk of spending in high risk categories, the credit controller 202 can notify an additional party should a charge violate a financial rule 210. The additional party can be a family member, friend or any other trusted party that can override or not override a credit card transaction. For example, a consumer could have a certain addiction, such as gambling or alcohol. A high risk category could be at a race track or at a bar. When a credit transaction occurs, the additional party could be notified of the transaction. The additional party can follow up with the consumer to make sure the consumer does not purchase alcohol or make bets before overriding a charge denial. In that example, a consumer may just be purchasing a meal at a bar/restaurant and the additional party can override the charge denial despite being in violating of a financial rule 210. In another example, a purchase attempt made in a high risk category can notify a consumer's sponsor for the sponsor to follow up with the consumer about the attempted purchase.

In one or more embodiments, the consumer can pre-define a policy where funds designated for one category can be moved to another category. For example, if the essentials category is at a certain threshold percentage usage, say 95%, and there is time left in the billing cycle, funds can be moved from another category, such as entertainment, to the essentials category as defined by the consumer's policy. The consumer policy can set certain thresholds such as before money is moved to another category, there needs to be a threshold amount of time left in the billing cycle and the category that has money being removed will need be under a certain spend threshold, such as 50%. These thresholds can be adjusted by the consumer or can cognitively be adjusted by the system 200 based on historical data 212. For example, if a category consistently exceeds its spending limit, the system 200 can adjust category spending limits based on this historical data 212.

In one or more embodiments, a credit card transaction can be denied by the system 200 based on data received from a linked bank account. For example, if the consumer defines a financial rule 210 that states the consumer does not wish to carry a balance on the credit card, the credit controller 202 can deny a charge if the resulting charge would cause the consumer to be unable to pay off the balance on the credit card at the end of the billing cycle.

In one or more embodiments, at the end of a billing cycle for a credit card, any remaining funds budgeted for spending by the card can be sent to a reserves category to assist a consumer in saving money.

In one or more embodiments, the credit controller 202 works between credit card authorization process for the credit card transaction system and the credit provider. In one or more embodiments, the credit card transaction system includes a point of sale system at a store, service center, or the like. The credit controller 202 performs authorization for credit charges before sending the charge to the credit provider. In one or more embodiments, the credit provider is a credit card company, a bank, or any other financial institution that extends credit. The credit controller 202 is a layer between the credit card transaction system and the credit provider and allows a card holder deny credit transactions that violate any financial rules 210. The credit controller 202 has a faster response time than a credit provider as it is card holder defined and is an intermediary between the point of sale and the credit provider.

In one or more embodiments, when a charge is declined for any reason, the card holder can be notified by any means, including but not limited to, the card holder profile 206, an email, text message, automated phone call, and the like. Upon notification, the card holder may override the financial rules associated with the credit card to authorize the transaction. Alternatively, the card holder may request additional information about the charge to decide whether to override and authorize or to accept the decline by a credit controller 202.

In one or more embodiments, based at least in part on the location and types of charges, the credit controller 202 can determine consumer was drinking and authorize a charge for a taxi cab or ride share. In one or more embodiments, if the credit card is maxed out, the credit controller 202 can request a credit extension from a credit provider to allow for safe travel home. In another embodiment, the credit card can be linked to a third party's credit card to allow for credit extension by third party for individual to get safe travel home.

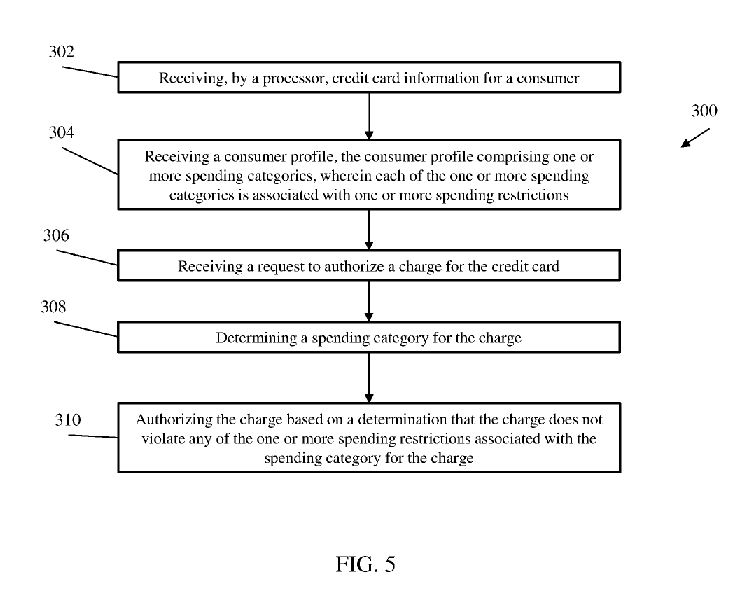

Referring now to FIG. 5 there is shown a flow diagram of a method for credit card authorization. The method 300 includes receiving, by a processor, credit card information for a consumer, as shown at block 302. At block 304, the method 300 include receiving a consumer profile, the consumer profile comprising one or more spending categories, wherein each of the one or more spending categories is associated with one or more spending restrictions. The method 300, at block 306, includes receiving a request to authorize a charge for the credit card. At block 308, the method 300 includes determining a spending category for the charge. The method 300, at block 310, includes authorizing the charge based on a determination that the charge does not violate any of the one or more spending restrictions associated with the spending category for the charge

Additional processes may also be included. It should be understood that the processes depicted in FIG. 5 represent illustrations, and that other processes may be added or existing processes may be removed, modified, or rearranged without departing from the scope and spirit of the present disclosure.

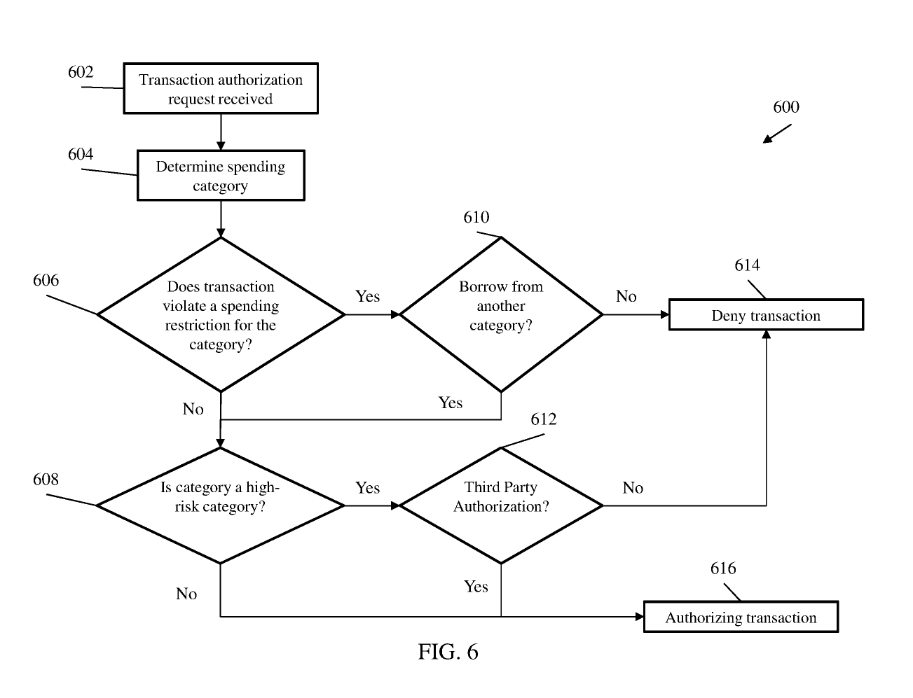

Referring now to FIG. 6 there is shown a flow diagram of an illustrative method 600 for credit card authorization according to one or more embodiments of the present invention. A credit card authorization request is received, as shown at block 602. Based at least in part on the charge associated with the credit card authorization request, a spending category is determined as shown at block 604. The spending category can be determined based on type of establishment the charge is coming from, such as a restaurant or retail store. Another way of determining the spending category can be based on the item or items being purchased. In one or more embodiments, if multiple items are being purchased, each item can be assigned a spending category with the spending limitations being applied per category based at least in part on the item or items purchased. The spending restrictions for each category are analyzed to determine if the credit card transaction violates any of the spending restrictions for the category, as shown in block 606. If the answer is Yes, at block 610, the method 600 looks to see if money can be borrowed from another category. If no other category can be borrowed from, the transaction is denied, as shown at block 614. If either money can be borrowed from another spending category or if the transaction does not violate a spending restriction, the spending category is looked at to see if it is a high risk spending category, as shown at block 608. If the answer is no, the transaction is authorized as shown at block 616. If the category is a high risk category, at block 612, a third party authorization is requested. If the third party authorization is denied, the transaction is denied as shown at block 614. If the third party authorization is allowed, the transaction is authorized as shown at block 616.

Additional processes may also be included. It should be understood that the processes depicted in FIG. 6 represent illustrations, and that other processes may be added or existing processes may be removed, modified, or rearranged without departing from the scope and spirit of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for credit card authorization, the method comprising:
receiving, by a processor, credit card information for a consumer;
receiving a consumer profile comprising one or more spending categories, wherein each of the one or more spending categories is associated with one or more spending restrictions;
receiving a request to authorize a charge for the credit card;
determining a spending category for the charge; and
authorizing the charge based on a determination that the charge does not violate any of the one or more spending restrictions associated with the spending category for the charge.

2. The method of claim 1 further comprising denying the charge based on a determination that the charge violates any of the one or more spending restrictions associated with the spending category for the charge.

3. The method of claim 1, wherein the at least one of the one or more spending restrictions is based on historical spending data for the consumer.

4. The method of claim 1, wherein the one or more spending categories includes a high risk category.

5. The method of claim 4 further comprising:
receiving a request to authorize a second charge for the credit card; and
determining a spending category for the second charge, wherein the spending category for the second charge is a high risk category.

6. The method of claim 5 further comprising denying the second charge based at least in part on the spending category for the second charge being a high risk category.

7. The method of claim 5 further comprising sending a notification to a third party based at least in part on the spending category for the second charge being a high risk category.

8. The method of claim 7, wherein the notification comprises a request for authorization for the second charge.

9. The method of claim 1, wherein the one or more spending restrictions associated with the one or more spending categories comprises a spending limit.

10. The method of claim 9, wherein the spending limit comprises two or more tiers.

11. A system for credit card authorization, the system having a processor coupled to a memory, the processor configured to:
receive credit card information for a consumer;
receive a consumer profile comprising one or more spending categories, wherein each of the one or more spending categories is associated with a spending restriction;
receive a request to authorize a charge for the credit card;
determine a spending category for the charge; and
authorize the charge based on a determination that the charge does not violate any of the one or more spending restrictions associated with the spending category for the charge.

12. The system of claim 11, wherein the processor is further configured to deny the charge based on a determination that the charge violates any of the one or more spending restrictions associated with the spending category for the charge.

13. The system of claim 11, wherein at least one of the one or more spending restrictions is based on historical spending data for the consumer.

14. The system of claim 11, wherein the one or more spending categories includes a high risk category.

15. The system of claim 14, wherein the processor is further configured to:
receive a request to authorize a second charge for the credit card;
determine a spending category for the second charge, wherein the spending category for the second charge is a high risk category; and
send a notification to a third party based at least in part on the spending category for the second charge being a high risk category.

16. A computer program product for credit card authorization, the computer program product comprising a computer readable storage medium having program instructions embodied therewith, the program instructions executable by a processor to cause the processor to perform:
receiving, by a processor, credit card information for a consumer;
receiving a consumer profile comprising one or more spending categories, wherein each of the one or more spending categories is associated with one or more spending restrictions;
receiving a request to authorize a charge for the credit card;
determining a spending category for the charge; and
authorizing the charge based on a determination that the charge does not violate any of the one or more spending restrictions associated with the spending category for the charge.

17. The computer program product of claim 16 further comprising denying the charge based on a determination that the charge violates any of the one or more spending restrictions associated with the spending category for the charge.

18. The computer program product of claim 16, wherein the at least one of the one or more spending restrictions is based on historical spending data for the consumer.

19. The computer program product of claim 16, wherein the one or more spending categories includes a high risk category.

20. The computer program product of claim 19 further comprising:
receiving a request to authorize a second charge for the credit card;
determining a spending category for the second charge, wherein the spending category for the second charge is a high risk category; and
sending a notification to a third party based at least in part on the spending category for the second charge being a high risk category.
